(19) United States
(12) Patent Application Publication
(10) Pub. No.: US 2020/0181835 A1
(43) Pub. Date: Jun. 11, 2020

(54) METHOD FOR PROCESSING PLANT MATERIAL AND RESPECTIVE PRODUCT

(71) Applicant: NOVA KAERU INDUSTRIA DE COUROS S.A., Três Rios (BR)

(72) Inventor: Eduardo Filgueiras Barbosa, Noguieira, Petrópolis (BR)

(21) Appl. No.: 16/615,715

(22) PCT Filed: May 21, 2018
(86) PCT No.: PCT/BR2018/050167

§ 371 Date: Nov. 21, 2019

(30) Foreign Application Priority Data
May 22, 2017 (BR) 10 2017 010 7140

(51) Int. Cl. D06N 3/02; C14C 11/00; C14C 3/02

(52) U.S. Cl. CPC D06N 3/02; C14C 11/003; D06N 2207/06; D06N 2211/106; D06N 2211/28; C14C 3/02

(57) ABSTRACT

A method for processing plant material for converting such material into a product with leather-like properties comprises chemical processing, or tanning, of the plant material to convert same into a feather-like material. The method comprises at least the steps of chemical processing, drying, and welding. The end-product is characterized by its similarity to leather and may be used in diverse areas of industry, such as clothing, footwear, bags, accessories, furniture, inter alia.

### CROSS-REFERENCE TO RELATED APPLICATIONS

This application is a national phase entry under 35 U.S.C. § 371 of International Patent Application PCT/BR2018/050167, filed May 21, 2018, designating the United States of America and published as International Patent Publication WO 2018/213907 A1 on Nov. 29, 2018, which claims the benefit under Article 8 of the Patent Cooperation Treaty to Brazilian Patent Application Serial No. BR 10 2017 010714 0, filed May 22, 2017.

### TECHNICAL FIELD

The present disclosure relates to a process for treating plant material for transforming it into a tanned product having characteristics similar to leather. The physical similarities between leather and the product described herein allow the use of the leather-like product in various applications. Therefore, it can be used in the tannery, as well as in clothing, footwear, handbags, accessories, furniture and other industries.

### BACKGROUND

The state of the art comprises products obtained from plant material that can be used in clothing, footwear, handbags, accessories, furniture and other industries. However, the raw materials used and the obtainment processes are completely different from those described and claimed herein, as it is clarified below.

The raw materials used to obtain the products claimed in this document are intact plant material, that is, they do not necessarily go through any cutting, grinding or other type of fragmentation process, so that the plant fibers remain intact and the plant material preserves its natural shape. The process disclosed herein can be comprehensively described as a treatment of the plant material for transforming the same into a product with characteristics similar to leather.

Products and processes that use plant material to obtain nonwoven products are described in US 20130149512 A1, which refers to a product obtained from pineapple leaves, and KR101611361 B1, which refers to a leather-like material obtained from cork.

With regard to leather, there are also products on the market obtained from organic material, but not only from plants, that mimic the appearance of leather, like those of the muskin brands, obtained from fungi; Jacroki, made of cellulose; and Barkcloth, made of tree barks (Moraceae tree).

The documents above describe products whose raw material and obtainment process are quite different from those claimed herein. Raw materials are not from intact vegetable parts, or their respective obtainment processes involve grinding plant parts. Some of the raw materials are not even of plant origin, or require preprocessing the plant material for being obtained, which is not necessary according to the process disclosed below.

None of the two references mentioned above teach how to treat plant material so that it is transformed into a leather-like product, as in the process and product described herein.

The present disclosure is different from traditional animal leather tanning processes in view that, due to the nature of the raw materials used, the chemical treatment was completely adapted in its steps, ingredients and respective concentrations, as described below.

### BRIEF SUMMARY

Basically, the products and processes claimed herein are intended to provide a plant material treatment process for transforming it into a product with leather-like characteristics.

The process claimed herein comprises the chemical treatment, or tanning, of plant material for transforming it into leather-like material. This process comprises at least the steps of chemical treatment, drying and welding. The final product is characterized by its similarity with leather, and can be applied to various fields of the industry, like clothing, footwear, handbags, accessories and furniture, among others.

A particular object of the process is transforming plant material into a leather-like product, so that such product serves as a leather substitute, whether of animal or synthetic origin, to be used in clothing, footwear, bags, luggage, backpacks, utensils and various accessories.

More particularly, the process comprises obtaining the product from intact plant material, that is, plant material that does not necessarily go through cutting, grinding or any type of fragmentation process, so that the plant fibers remain intact and the plant material preserves its natural shape.

The raw materials used to obtain the products claimed herein are, preferably, intact plant material, that is, plant material that does not necessarily go through any preprocessing for extracting or modifying components, or cutting, grinding or any type of fragmentation process, so that the plant fibers remain intact and the plant material preserves its natural shape. A particular object is the use of fresh and intact plant material, and its processing without using environmentally toxic chemicals, like heavy metals.

### BRIEF DESCRIPTION OF THE DRAWINGS

FIG. 1 shows examples of the product claimed herein.

FIG. 2 shows the product submitted to abrasion test.

FIG. 3 shows a comparison between a newly product (A) claimed herein and another that underwent an aging acceleration test (B) (72 h at 100° C.).

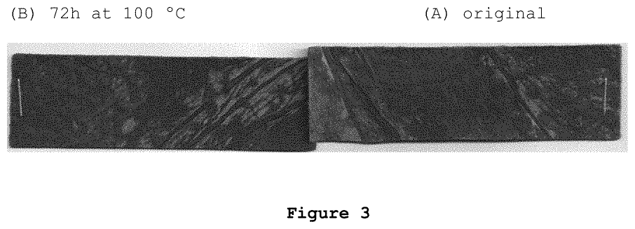

FIG. 4 shows a footwear made of the product claimed herein.

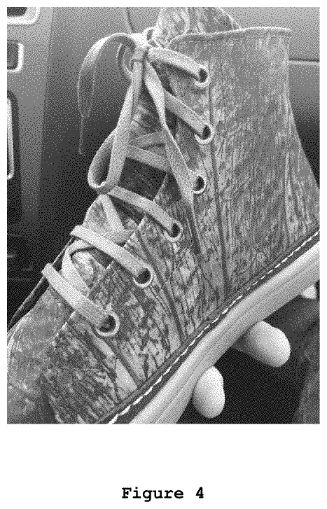

### DETAILED DESCRIPTION

The first embodiment describes a process for treating plant material to transform it into a product whose appearance and physical characteristics are similar to leather. The process comprises the basic steps of chemically treating the plant material, drying and welding the product.

In a specific embodiment of the process, the chemical treatment of the plant material comprises acidification, whitening, lubrication, tanning and fixation. The step of chemically treating the plant material can be done, for example, in a pot, or similar container, comprising the necessary chemical components, or in industrial machines suitable for the process.

The acidification substep can be done with any organic acid, e.g., formic acid or acetic acid. The whitening substep can be done with any bleaching agent, like sodium chlorite or sodium hypochlorite. The lubrication step can be done, for example, with sulfide oils, sulphated oils, fatty alcohol, fish oil, vegetable oil, mineral oil and synthetic oils.

The tanning substep could still be divided, by an individual skilled in the art under discussion, between pre-tanning and tanning. However, to simplify the description and facilitate the understanding of the process, the substep is simply named tanning, and the following ingredients are examples of compounds that may be useful for tanning the plant organic material: glutaraldeide, phosphonium, oxyziridine, sulphone, phenolic synthetic tannin, vegetable tannin, micronized tare, chromium, aluminum, zirconium, acrylic resin and various polymers.

The fixing substep can be performed, for example, with an organic acid, like formic acid or acetic acid.

In an alternative embodiment of the process, the chemical treatment step of the plant material still comprises sterilization; washing; and buffering, acidification or alkalinization of the chemical treatment environment. Such optional steps can be done at any time in the process, according to the need to stabilize the system and prevent growth of microorganisms, like fungi and bacteria.

For example, a sterilization, buffering, acidification or alkalinization step can be done between steps, for example, between acidification and whitening; between tanning and lubrication; between lubrication and tanning; between tanning or lubrication and fixation; or even concomitantly with any of acidification, whitening, tanning, lubrication or fixation steps.

In a preferred embodiment of the process, the substeps of tanning and lubrication are repeated during the process. For example, such substeps can be carried out after whitening, after lubrication or after a sterilization step and buffering, acidification or alkalinization.

Optionally, the process claimed herein further comprises a step of thermoplastic treatment of the product obtained in the welding step. A thermoplastic binder can be used in such step, e.g., polyethylene (PE), polypropylene (PP) and polyvinyl chloride (PVC). Thermoplastic treatment can be done, for example, with an atomizer apparatus.

Steps for strengthening the obtained product, like gluing or sewing with other material that provides greater tear resistance, can be included in the process claimed herein.

The drying step can be done in any environment under convection currents, whether outdoor or in an appropriate industrial apparatus, in a manner that the entire product surface of step A is exposed to such currents, so that drying occurs efficiently. Drying can occur at room temperature, or in a greenhouse, at a temperature of 25-75° C., preferably from 30-60° C., or from 40-50° C.

By its turn, product welding obtained can be carried out according to a method and using an appropriate anchoring film, for example, the method and film described in patent PI 0103938-5 of Sep. 6, 2011, which is incorporated herein by reference. Optionally, after welding, the finishing and final coloring of the product may be carried out to achieve various aesthetic effects.

In a preferred embodiment of the process, the plant material can be selected from leaf, flower, fruit, infructescence, stem, root and seed, and parts thereof.

It is also claimed herein a product obtained by the processes described above. This product is characterized by comprising plant material transformed by the process described above.

The product claimed herein can be also characterized by the fact that the plant material has its aqueous content replaced by non-aqueous compounds, like oils and glycerin. The aqueous content can be fully or partially replaced. Optionally, the product claimed herein can be also characterized by comprising intact vegetable fibers.

### EXAMPLE

The following example aims only to illustrate what has been described above, in order to facilitate the understanding of a person skilled in the art. However, it is not intended to limit the description or the scope of this patent to the embodiments below:

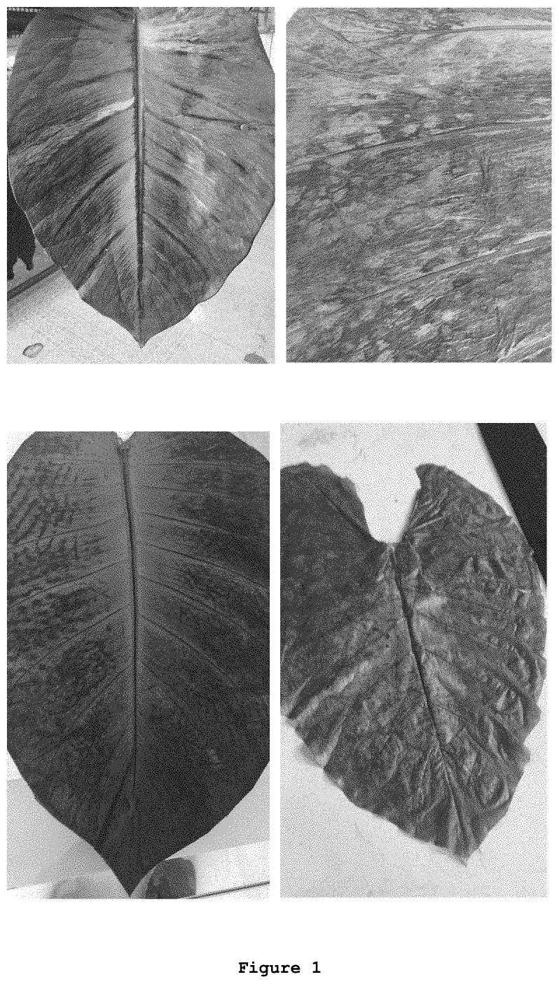

The chosen plant material were leaves, as shown in FIG. 1.

Acidification of plant material can be done in aqueous solution of formic acid 0.5%-10%, in pH from 1.5 to 4.5, for a period of 24 hours. After that, the plant material can be bleached in sodium chlorite 0.1%-10%, for 30 minutes, and lubricated with glycerin 1%-40% and synthetic oil 0.5%-6% for 24 hours. Tanning of plant material can be done with glutaraldehyde 1%-8% and phosphonium 1%-8%, and the material can be sterilized with a fungicide. In order to balance the pH, a sodium acetate buffer 0.4-4.8% can be used to keep pH between 3 and 7. At that time, a lubrication step may be desirable and, for this purpose, glycerin 1%-40% can be used. For a new tanning of the material, tanning substances, like sulphone 2%-27% and acrylic resin 1%-17%, can be used. So far, the processed plant material can be washed with water and optionally with sodium bicarbonate.

Continuing the tanning process, synthetic oil 1%-20%, lecithin oil 1%-20%, synthetic polymer 1%-20%, glycerin 1%-20% and acrylic resin 1%-17% can be used, for example, for 2 hours. To finish the process, the plant material can pass again through treatment with fungicides before fixation, which can be performed with formic acid 0.5%-10%.

Treated leaves can be exposed to convection currents, e.g., outdoor. After drying, the leaves can pass through the welding step, as described in patent PI 0103938-5 of Sep. 6, 2011. After welding, the leaves can optionally undergo the treatment with thermoplastics, paints and others, obtaining a product as shown in FIG. 1.

The product obtained in the example above has the following physical properties described in the tables below:

TABLE 1
Abrasion resistance

| | |
|---|---|
| 500 g/500 cycles/abrasive | There was light |
| wheels CS-10 | wear on finish |
| Mass loss | 6.6 mg |

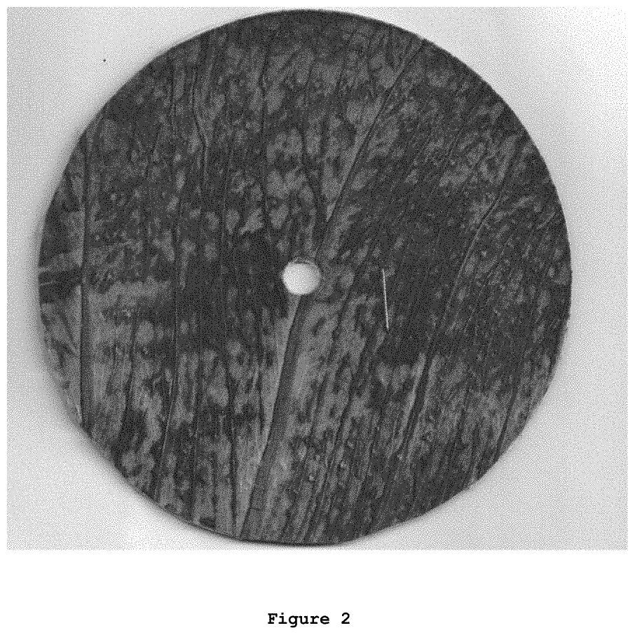

The method for determining the data indicated in table 1 is based on standard DIN EM 14327:04. FIG. 2 shows the product before and after being submitted to abrasion test.

TABLE 2
Tear load

| | Sample A | Sample B |
|---|---|---|
| Thickness | 0.70 mm | 0.77 mm |
| Maximum tear load | 31.3N | 38.0N |

Tear load determination is based on standard DIN EM ISSO 3377-3:03/IUP 8.

TABLE 3
Tensile strength and extension percentage

| | Sample A | Sample B |
|---|---|---|
| Thickness | 0.80 mm | 1.0 mm |
| Load on breakage | 126.2N | 154.7N |
| Stress on breakage | 15.7N/mm² | 15.5N/mm² |
| Stretching on breakage | 185.8% | 236.0% |

The determination of data in table 3 was made according to DIN EM ISO 3374:12

The physical similarities between leather and the product claimed herein allow the use of the product currently claimed like leather, in various applications.

1. A process of treating plant material, comprising the steps of:
a) chemical treatment of plant material;
b) drying a product obtained in the chemical treatment step; and
c) welding the product obtained in the product drying step.

2. The process of claim 1, wherein it further comprises the following step:
d) thermoplastic treatment of the product obtained in step b.

3. The process of claim 1, wherein the chemical treatment of plant material comprises acidification, whitening, lubrication, tanning and fixation.

4. The process of claim 3, further comprising repeating the tanning and fixation.

5. The process of claim 3, further comprising one or more steps of buffering, acidification or alkalinization.

6. The process of claim 3, wherein it optionally comprises one or more steps of sterilizing the plant material.

7. The process of claim 2, wherein the thermoplastic treatment of the material obtained in step b is carried out with a thermoplastic binder.

8. The process of claim 1, wherein the plant material is selected from leaf, flower, fruit, pseudofruit, infructescence, stem, root and seed, as well as parts thereof.

9. A product formed by the process of claim 1.

10. The product of claim 9, wherein aqueous content of the plant material is replaced by non-aqueous compounds.

11. The product of claim 9, wherein the plant material comprises intact vegetable fibers.

12. The product of claim 9, wherein the plant material is selected from leaf, flower, fruit, pseudofruit, infructescence, stem, root and seed, as well as parts thereof.
